(19) United States
(12) Patent Application Publication
(10) Pub. No.: US 2025/0217178 A1
(43) Pub. Date: Jul. 3, 2025

(54) DISTRIBUTED HOST VALIDATION ENGINE FOR NETWORKING CONTROL PLANE IN A SOFTWARE DEFINED NETWORK

(71) Applicant: MICROSOFT TECHNOLOGY LICENSING, LLC, Redmond, WA (US)

(72) Inventor: Avijit GUPTA, Redmond, WA (US)

(21) Appl. No.: 18/399,606

(22) Filed: Dec. 28, 2023

(51) Int. Cl. G06F 9/455

(52) U.S. Cl. CPC G06F 9/45558; G06F 2009/45579; G06F 2009/45595

(57) ABSTRACT

Techniques are described for a validation engine configured to verify user goal states in a virtualized computing environment comprising a plurality of hosts executing a plurality of virtual machines or containers. A representation of a user goal state encoding an updated state is received and queries are sent to control plane components to obtain current states of hosts in the network. The current states and local configurations are verified to be consistent with the user goal state.

### BACKGROUND

It is difficult to ensure coverage of all corner cases for a given user configuration and associated workflows in a software defined network (SDN). For example, a series of unit tests are typically written to test different configurations and confirm that what is programmed on the host fulfills the intended objectives. However, it is difficult to verify every condition and avoid gaps in test coverage, which can ultimately result in potential service interruptions.

It is with respect to these considerations and others that the disclosure made herein is presented.

### SUMMARY

The present disclosure describes a validation engine that works to support complex cloud network test configurations based on user goal states. The validation engine runs on each host or runs remotely and communicates with each host and verifies that the actual configuration achieves the goal state for a user network. The validation engine queries control plane components to obtain specific goal set data, and compares what is programmed against the goal set data by sending agents to each host to verify local configurations. Goal states are persisted and translated to network appliances. Goal states received on each host are automatically compared to what was programmed. The process is proliferated to thousands and millions of nodes in a network. The validation engine thus enables a massively distributed test engine that can automatically perform millions of tests and cover test cases for a production environment.

The described techniques can allow for a service provider or customer to more efficiently update and deploy computing resources while maintaining efficient use of computing capacity such as processor cycles, memory, network bandwidth, and power.

This Summary is provided to introduce a selection of concepts in a simplified form that are further described below in the Detailed Description. This Summary is not intended to limit the scope of the claimed subject matter.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1A is a diagram illustrating an example architecture in accordance with the present disclosure;

FIG. 1B is a diagram illustrating an example architecture in accordance with the present disclosure;

FIG. 2 is a diagram illustrating an example architecture in accordance with the present disclosure;

FIG. 3 is a diagram illustrating an example architecture in accordance with the present disclosure;

FIG. 4 is a flowchart depicting an example procedure for managing computing resources in accordance with the present disclosure;

FIG. 5 is an example computing system in accordance with the present disclosure.

### DETAILED DESCRIPTION

Verifying a stable deployment which is robust, efficient and secure is often challenging. Deploying or updating an application in the cloud as a cloud service is not straightforward because of the many factors that need to be taken into account. For example, test frameworks are often adapted to a specific solution and configurations for that solution, which requires a significant of resources. Additionally, when various cloud products are deployed, they are hosted on a single. Comparing and contrasting how different platforms perform requires completely different configurations of the test environment. This can be extremely costly both in computing resources required and engineering labor.

The disclosed embodiments describe a validation engine that works to support complex cloud network test configurations based on user goal states. A validation engine (which may also be referred to herein as a host validation engine) runs on each host and verifies that the actual configuration achieves the goal state for a user network. The validation engine queries control plane components to obtain specific goal set data, and compares what is programmed against the goal set data by sending agents to each host to verify local configurations. Goal states are persisted and translated to network appliances. Goal states received on each host are automatically compared to what was programmed. The process is proliferated to thousands and millions of nodes in a network. The disclosed embodiments thus enable a massively distributed test engine that can automatically perform millions of tests and cover test cases for a production environment.

The described techniques can allow a user to access results for multiple products and test configurations at a centralized location or the same product on different platforms or test configurations and compare performance side by side. This also enables more consistency with the tests. By leveraging the test configurations, the validation engine can interface with different configurations and with different platforms. Furthermore, allowing the configurations to be modular enables easy functional and performance testing of the product or device under test. The configurations enable users to test products without having to expend resources individually creating interfaces for each configuration.

The disclosure provides a validation engine that works to support complex cloud network test configurations based on user goal states. A validation engine runs on each host and verifies that the actual configuration achieves the goal state for a user network. The validation engine queries control plane components to obtain specific goal set data and compares what is programmed against the goal set data by sending agents to each host to verify local configurations. Goal states are persisted and translated to network appliances. Goal states received on each host are automatically compared to what was programmed. The process is proliferated to thousands and millions of nodes in a network. The disclosed embodiments thus enable a massively distributed test engine that can automatically perform millions of tests and cover test cases for a production environment.

The validation engine can run on each host of the SDN where virtual machines (VMs) are hosted. However, running the validation engine on each host can consume host resources that can be used for user tasks. In a distributed environment, the validation engine can be situated as a remote service in the data center. The validation engine receives user goal states associated with each user, which allows validation of customer deployments across all data center deployments, which in turn enables complete code coverage because every possible scenario for a configuration can be tested without having to individually author all of the unit tests. All new scenarios that are onboarded in the data center are onboarded to this validation engine to enable continuous coverage of user goal states. When a customer activates a given scenario, the validation engine can determine the goal state and the expected programming state, which allows the validation engine to verify whether the goal state results in the expected state without having to author each and every unit test. From a testing perspective, the validation engine augments running individual tests of a customer's configuration and more quickly and efficiently identifies issues in production before they become issues with a customer.

The validation engine includes a data driver or data driver adapter and an SDN device abstraction layer which interacts with various software defined networking devices and associated data path drivers, and accesses what is programmed on the drivers. In one implementation the validation engine interacts with agents that run on all appliances and hosts. This enables the validation engine to constantly validate call states with what is actually programmed.

In some embodiments, the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

Referring to the appended drawings, in which like numerals represent like elements throughout the several FIGURES, aspects of various technologies for remote management of computing resources will be described. In the following detailed description, references are made to the accompanying drawings that form a part hereof, and which are shown by way of illustration specific configurations or examples. While many examples are described using servers and disks, it should be understood that other types of compute nodes and storage devices may be used in other embodiments.

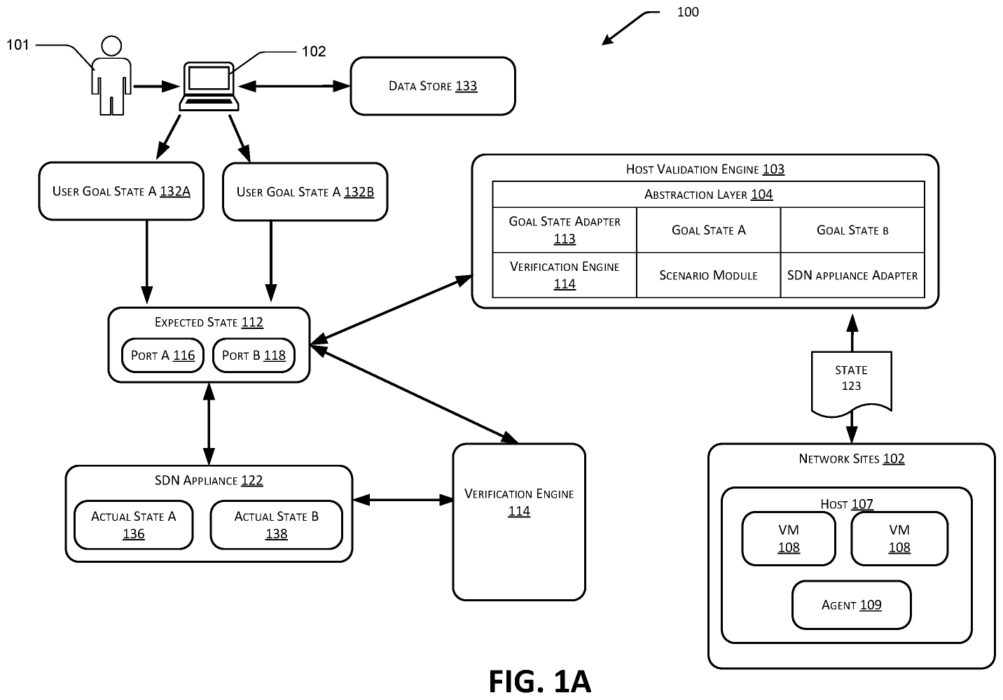

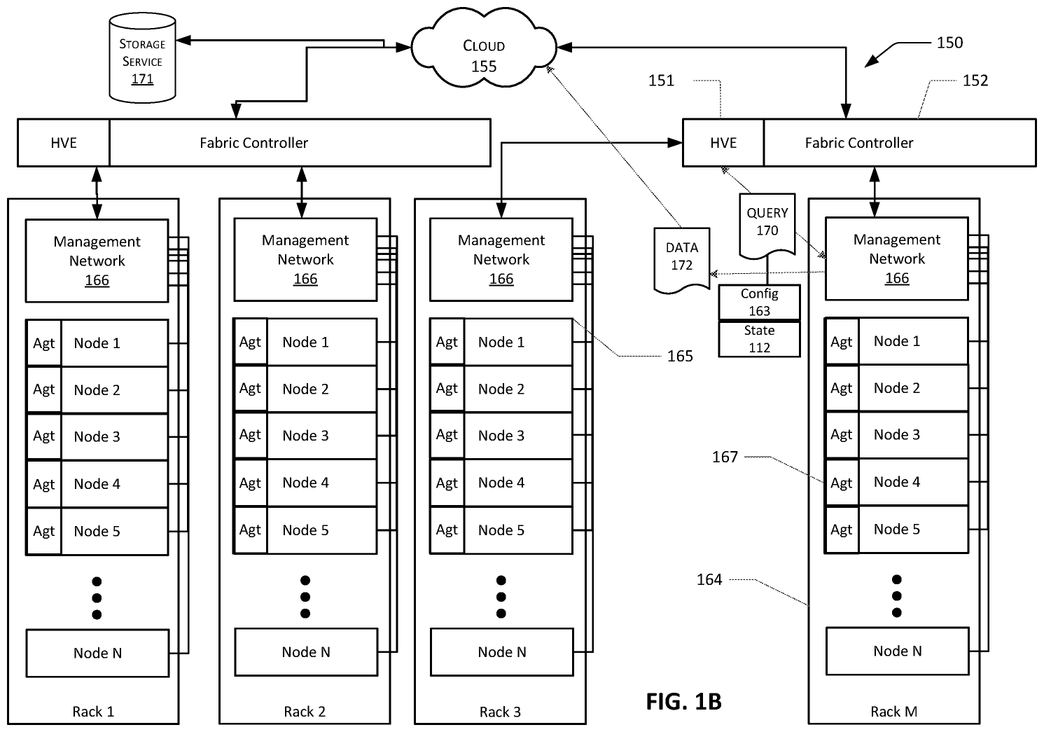

With reference to FIG. 1A, illustrated is a virtualized computing environment 100 that includes a validation engine 103. Validation engine 103 is configured to verify user goal states 132A and 132B in the virtualized computing environment 100. The virtualized computing environment 100 comprises a plurality of hosts 107 executing a plurality of virtual machines or containers 108. The validation engine 103 receives user goal states 132A and 132B encoding an updated state of the virtualized computing environment 100. User goal states 132A and 132B can include policies associated with a user of the virtualized computing environment 100. The validation engine 103 is configured to execute an abstraction layer 104 configured to process the user goal states 132A and 132B to expected state 112 usable to verify the state 123 in host 107. In an embodiment, the abstraction layer 104 comprises a goal state adapter 113 and verification engine 114. Agents 109 are configured to validate the equivalent commands and responses. The validation engine 103 is configured to compare the actual state 136, 138 with expected state 112.

The user goal states 132A, 132B can include one or more statements in a standardized format that is readable by test units, management tools, etc. For example, the user goal states 132A, 132B can be written in a markup language. A user goal state 132A, 132B can have one or more expressions which have concrete values and/or a reference to another user goal state 132A, 132B. The user goal state 132A, 132B can have a mapping. A data store 133 of user goal states 132A, 132B is optionally available. In some cases the user goal states 132A, 132B in the store 133 have associated version numbers.

An operator 101 uses computer 102 to enter a user goal state 132A, 132B. The operator 101 enters the user goal state 132A, 132B manually and optionally by including references to one or more other user goal states 132A, 132B from store 133. The operator 101 is provided the option to include references within user goal state 132A to other user goal states 132A, 132B in order to create more complex user goal states 132A, 132B. The abstraction layer 103 processes the user goal state 132A, 132B into expected state 112 which is suitable for input to the SDN appliance 122.

In one embodiment, abstraction layer 104 includes functionality that uses a data-driven model that uses goal state adapter 113 to generate the configured state 112 based on the user goal state 132A, 132B statements, configuration data, and other information. In an embodiment, the user goal state 132A, 132B and configuration data, and other information can be specific to a particular network site 102 where the host 107 is deployed. The translation layer can include a classifier and can database 104 which can include one or more tables or other data structures.

Once the output test script 122 is received at the orchestrator 112 the orchestrator executes the output test script 122 in order to test the function 109 in the first platform 102 or second platform 112. In some embodiments, the operator can enter a revision to the input test script 132A, 132B. The output test script 122 can be updated to effect the revision.

Referring to FIG. 1B, illustrated is a cloud service with a data center 150 and a validation engine 151 that is capable of communicating with nodes 165 in the data center 150. In an embodiment, the validation engine 151 runs on a fabric controller 152 in a control plane of the data center 150 and communicates with nodes 165 using a network connection that is available on a controller of each node 110. The validation engine 151 has a distributed service architecture implemented at the cloud infrastructure and communicates with nodes 165 and clusters (not shown) in the data center as shown in FIG. 1B. The nodes can be servers that are arranged in racks 164.

FIG. 1B illustrates one example of how a validation engine architecture can be arranged in data center 150. Data center 150 contains physical racks 114 which consist of multiple nodes 165 (e.g., servers) racked/placed per rack 164. Each rack 164 provides power supply to the nodes 165 and a management network infrastructure 166 for each rack 164. The management network infrastructure 166 in FIG. 1B represents a network infrastructure for the data center 150 and can include network switches, VLAN and network topologies, etc. according to data center requirements.

The validation engine 151 is part of the management/control plane in data center 150. In an embodiment, the validation engine 151 runs on fabric controller 152 which comprises a pool of physical servers which hosts multiple management services that manage allocated server racks. A data center supervisor/operator can log in to the validation engine 151 and perform status checks and initiate action on the individual nodes 165 as needed. The validation engine 151 communicates to the agents 167 that are running on the various nodes 165 over a network connection. The validation engine 151 can check current monitoring parameters, error logs, and events from each node 165 by requesting the data from the agents 167. The validation engine 151 can send a new payload to the agents 167 which can be configuration files 163, configured states 112, etc.

In an embodiment, the validation engine 151 is hosted on the fabric controller 152 as shown FIG. 1B. In an example, an operator logs into validation engine 151 and configures the required configuration files 163 and agent 167 that are to be pushed to each node 165 in the data center 150. In an embodiment, the validation engine 151 is hosted locally inside data center 150 on each of the fabric controllers 152 to avoid network latency, deployment latency, etc. and to enable real time configuration changes when possible. If configuration files 163 or agents 167 need to be pushed remotely from a global cloud service via cloud 155 to the individual nodes 165 in the data center 150, this may include multiple transmission hops, monitoring of the deployment of the configuration files 163, monitoring of possible deployment aborts, etc. which need to be monitored with varying processes. By pushing such functions locally onto the fabric controllers 102, the complexity of the validation process can be reduced.

The validation engine 151 also sends information about the current configuration file 120 and agent 167 for each node to the cloud service provider via cloud 105 for storage on databases such as storage service 171 which can be viewed remotely by any operator. The validation engine 151 also maintains audit logs containing the time when configuration files 163 and agents 167 were pushed for auditing and monitoring purposes.

An operator 101 is able to set the user goal states 132A to a system managed by validation engine 103 by inputting a user goal state component via a computing device 102 that is indicated by user goal states 132A. Other input can be included such as policy 132B. In an embodiment, goal state components may be selected from a data store 133 of previously created and saved goal state components. The goal state as indicated by the representation 132A specifies what configuration end state is desired, what instances 108 are to be affected, and what set of policies and rules are to be followed. In an embodiment, the goal state can be represented in a configuration file. The configuration can include a policy indicative of constraints for changes that are permitted in the network and a current state of the network. A deployment engine 114 uses the configured state 112 and communicates with agent 109.

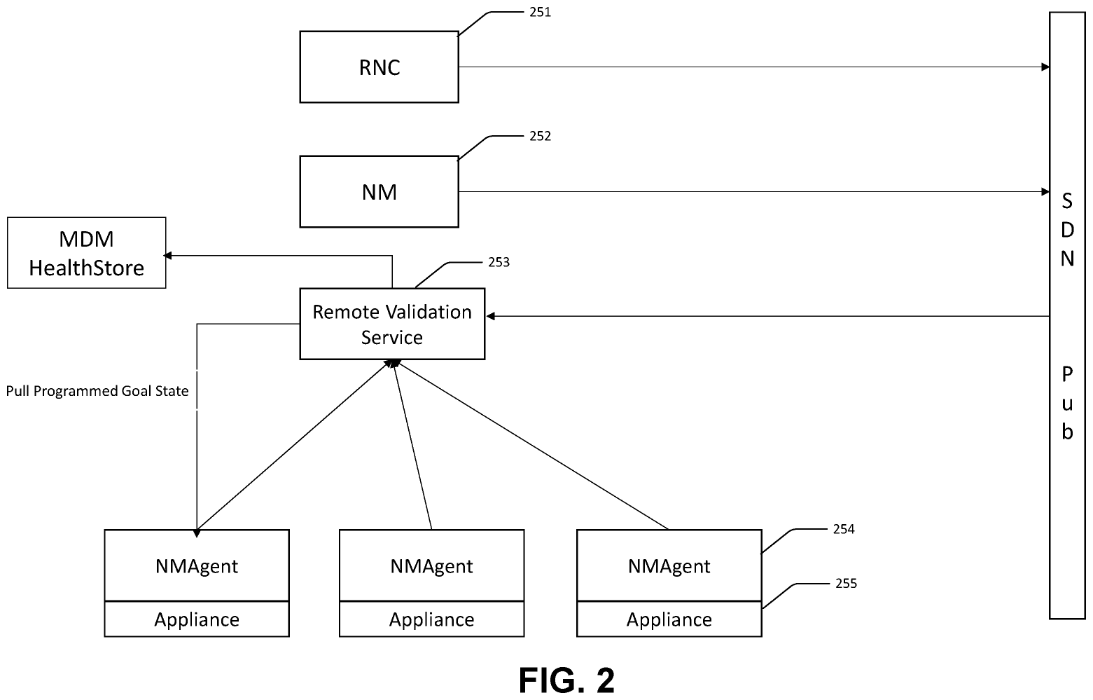

FIG. 2 further illustrates that the validation engine can generally be referred to as a remote validation service 253 and interacts with agents 254 on network appliances 255. The remote validation service 253 interacts with services such as network manager (NM) 252 and remote network controller (RNC) 251.

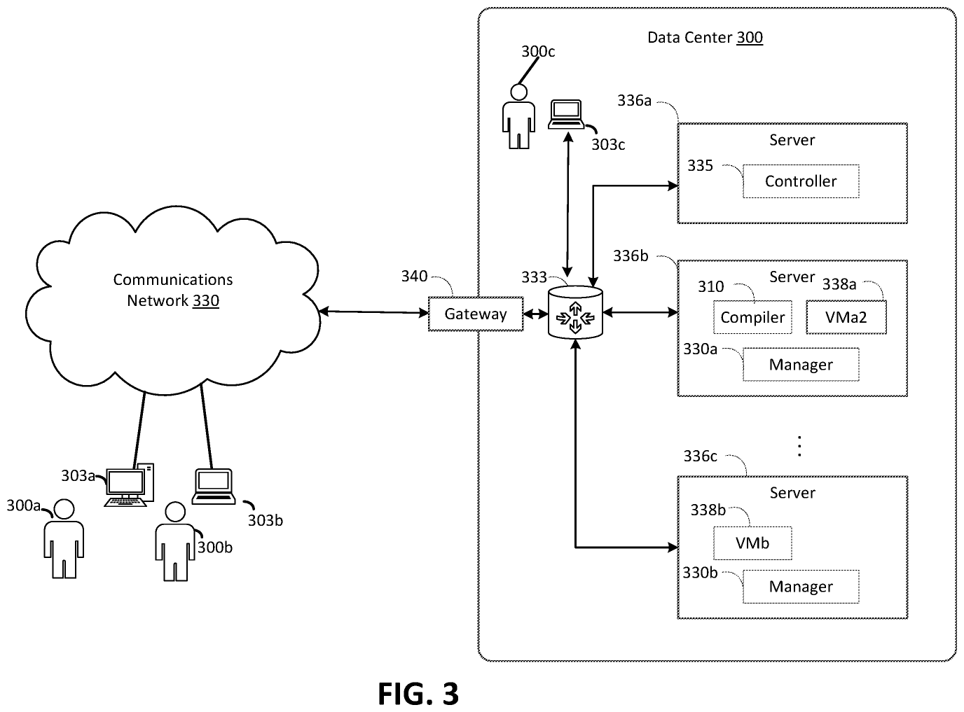

FIG. 3 illustrates an example computing environment in which the embodiments described herein may be implemented. FIG. 3 illustrates a data center 300 that is configured to provide computing resources to users at the customer environment. The customer environment may have user computers that may access services provided by data center 300 via a network 330. The computing resources provided by the data center 300 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like.

Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor). Networking resources may include virtual networking, software load balancer, and the like. The virtual machines may be configured to execute applications, including Web servers, application servers, media servers, database servers, and the like. Data storage resources may include file storage devices, block storage devices, and the like.

Data center 300 may have various computing resources including servers, routers, and other devices that may provide remotely accessible computing and network resources using, for example, virtual machines. Other resources that may be provided include data storage resources. Data center 300 may also execute functions that manage and control allocation of network resources, such as a network manager 330a.

Network 330 may, for example, be a publicly accessible network of linked networks and may be operated by various entities, such as the Internet. In other embodiments, network 330 may be a private network, such as a dedicated network that is wholly or partially inaccessible to the public. Network 330 may provide access to computers and other devices at the customer environment.

The disclosed embodiments may be implemented in a mobile edge computing (MEC) environment implemented in conjunction with a 4G, 5G, or other cellular network. The MEC environment may include at least some of the components and functionality described in FIG. 1 above. Additionally, components of a 5G network may include network functions such as a Session Management Function (SMF), Policy Control Function (PCF), and N7 interface. A radio access network (RAN) may comprise 5G-capable UEs, a base station gNodeB that communicates with an Access and Mobility Management Function (AMF) in a 5G Core (5GC) network. The 5G network may further comprise a User Plane Function (UPF) and Policy Charging Function (PCF).

It should be appreciated that although the embodiments disclosed above are discussed in the context of virtual machines, other types of implementations can be utilized with the concepts and technologies disclosed herein. It should be also appreciated that the network topology illustrated in FIG. 3 has been greatly simplified and that many more networks and networking devices may be utilized to interconnect the various computing systems disclosed herein. These network topologies and devices should be apparent to those skilled in the art.

FIG. 3 illustrates that computing resources are provided to users 300a, 300b, or 300c (which may be referred herein singularly as “a user 300” or in the plural as “the users 300”) via user computers 303a,303b, and 303c (which may be referred herein singularly as “a computer 303” or in the plural as “the computers 303”) via communications network 330.

Data center 300 may include servers 336a, 334, and 336c (which may be referred to herein singularly as “a server 336” or in the plural as “the servers 336”) that may be standalone or installed in server racks, and provide computing resources available as virtual machines 338a and 338b (which may be referred to herein singularly as “a virtual machine 338” or in the plural as “the virtual machines 338”). The virtual machines 338 may be configured to execute applications such as Web servers, application servers, media servers, database servers, and the like. Other resources that may be provided include data storage resources (not shown on FIG. 3) and may include file storage devices, block storage devices, and the like. Servers 336 may also execute functions that manage and control allocation of resources in the data center, such as a controller 335. Controller 335 may be a fabric controller or another type of program configured to manage the allocation of virtual machines on servers 336.

In an embodiment, a compiler 310 as described herein may be implemented in server 334. The compiler 310 may include a mapping layer as further described herein (not shown in FIG. 3).

Referring to FIG. 3, communications network 330 may, for example, be a publicly accessible network of linked networks and may be operated by various entities, such as the Internet. In other embodiments, communications network 330 may be a private network, such as a corporate network that is wholly or partially inaccessible to the public.

Communications network 330 may provide access to computers 303. Computers 303 may be computers utilized by users 300. Computer 303a, 303b or 303c may be a server, a desktop or laptop personal computer, a tablet computer, a smartphone, a set-top box, or any other computing device capable of accessing data center 300. User computer 303a or 303b may connect directly to the Internet (e.g., via a cable modem). User computer 303c may be internal to the data center 300 and may connect directly to the resources in the data center 300 via internal networks. Although only three user computers 303a,303b, and 303c are depicted, it should be appreciated that there may be multiple user computers.

Computers 303 may also be utilized to configure aspects of the computing resources provided by data center 300. For example, data center 300 may provide a Web interface through which aspects of its operation may be configured through the use of a Web browser application program executing on user computer 303. Alternatively, a stand-alone application program executing on user computer 303 may be used to access an application programming interface (API) exposed by data center 300 for performing the configuration operations.

Servers 336 may be configured to provide the computing resources described above. One or more of the servers 336 may be configured to execute a manager 330a or 330b (which may be referred herein singularly as “a manager 330” or in the plural as “the managers 330”) configured to execute the virtual machines. The managers 330 may be a virtual machine monitor (VMM), fabric controller, or another type of program configured to enable the execution of virtual machines 338 on servers 336, for example.

It should be appreciated that although the embodiments disclosed above are discussed in the context of virtual machines, other types of implementations can be utilized with the concepts and technologies disclosed herein.

In the example data center 300 shown in FIG. 3, a network device 333 may be utilized to interconnect the servers 336a and 334. Network device 333 may comprise one or more switches, routers, or other network devices. Network device 333 may also be connected to gateway 340, which is connected to communications network 330. Network device 333 may facilitate communications within networks in data center 300, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 3 has been greatly simplified and that many more networks and networking devices may be utilized to interconnect the various computing systems disclosed herein. These network topologies and devices should be apparent to those skilled in the art.

It should also be appreciated that data center 300 described in FIG. 3 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

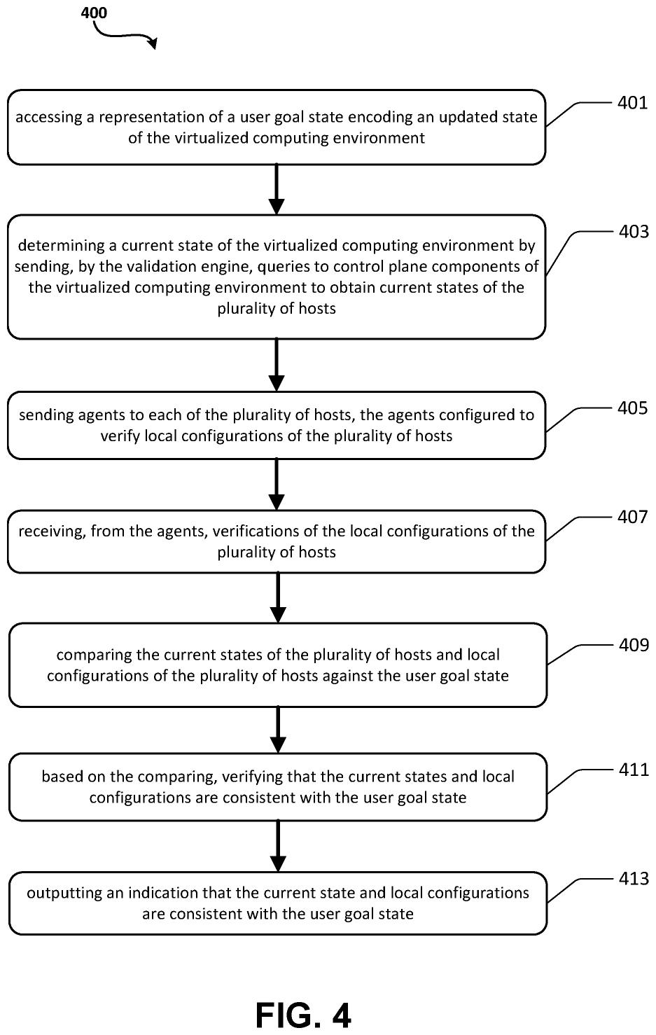

Turning now to FIG. 4, illustrated is an example operational procedure for verifying user goal states in a virtualized computing network. In an embodiment, the virtualized computing environment comprises a plurality of hosts executing a plurality of virtual machines. Such an operational procedure can be provided by one or more components illustrated in FIGS. 1 through 3. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 400 is described as running on a system, it can be appreciated that the routine 400 and other operations described herein can be executed on an individual computing device or several devices.

Referring to FIG. 4, operation 401 illustrates accessing a representation of a user goal state encoding an updated state of the virtualized computing environment.

Operation 403 illustrates determining a current state of the virtualized computing environment by sending, by the validation engine, queries to control plane components of the virtualized computing environment to obtain current states of the plurality of hosts.

Operation 405 illustrates sending agents to each of the plurality of hosts, the agents configured to verify local configurations of the plurality of hosts.

Operation 407 illustrates receiving, from the agents, verifications of the local configurations of the plurality of hosts.

Operation 409 illustrates comparing the current states of the plurality of hosts and local configurations of the plurality of hosts against the user goal state.

Operation 411 illustrates based on the comparing, verifying that the current states and local configurations are consistent with the user goal state.

Operation 413 illustrates outputting an indication that the current state and local configurations are consistent with the user goal state.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a) a case in which at least some tasks are implemented in hard ASIC logic or the like; b) a case in which at least some tasks are implemented in soft (configurable) FPGA logic or the like; c) a case in which at least some tasks run as software on FPGA software processor overlays or the like; d) a case in which at least some tasks run as software on hard ASIC processors or the like, etc., or any combination thereof. A component may represent a homogeneous collection of hardware acceleration devices, such as, for example, FPGA devices. On the other hand, a component may represent a heterogeneous collection of different types of hardware acceleration devices including different types of FPGA devices having different respective processing capabilities and architectures, a mixture of FPGA devices and other types hardware acceleration devices, etc.

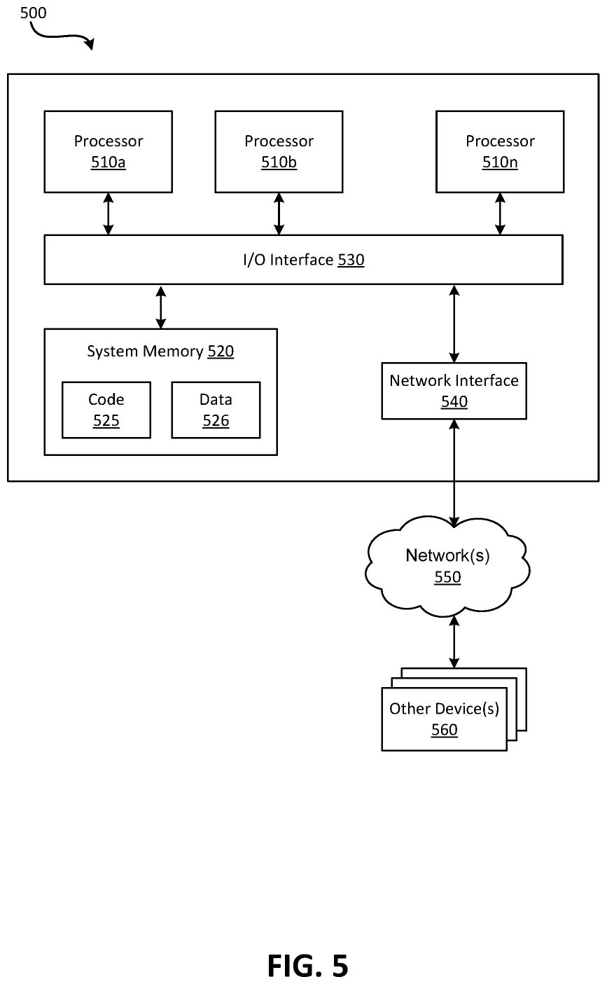

FIG. 5 illustrates a general-purpose computing device 500. In the illustrated embodiment, computing device 500 includes one or more processors 510a, 510b, and/or 510n (which may be referred herein singularly as “a processor 510” or in the plural as “the processors 510”) coupled to a system memory 520 via an input/output (I/O) interface 530. Computing device 500 further includes a network interface 540 coupled to I/O interface 530.

In various embodiments, computing device 500 may be a uniprocessor system including one processor 510 or a multiprocessor system including several processors 510 (e.g., two, four, eight, or another suitable number). Processors 510 may be any suitable processors capable of executing instructions. For example, in various embodiments, processors 510 may be general-purpose or embedded processors implementing any of a variety of instruction set architectures (ISAs), such as the x55, PowerPC, SPARC, or MIPS ISAs, or any other suitable ISA. In multiprocessor systems, each of processors 510 may commonly, but not necessarily, implement the same ISA.

System memory 520 may be configured to store instructions and data accessible by processor(s) 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 520 as code 525 and data 526.

In one embodiment, I/O interface 530 may be configured to coordinate I/O traffic between the processor 510, system memory 520, and any peripheral devices in the device, including network interface 540 or other peripheral interfaces. In some embodiments, I/O interface 530 may perform any necessary protocol, timing, or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components. Also, in some embodiments some or all of the functionality of I/O interface 530, such as an interface to system memory 520, may be incorporated directly into processor 510.

Network interface 540 may be configured to allow data to be exchanged between computing device 500 and other device or devices 560 attached to a network or network(s) 550, such as other computer systems or devices as illustrated in FIGS. 1 through 5, for example. In various embodiments, network interface 540 may support communication via any suitable wired or wireless general data networks, such as types of Ethernet networks, for example. Additionally, network interface 540 may support communication via telecommunications/telephony networks such as analog voice networks or digital fiber communications networks, via storage area networks such as Fibre Channel SANs or via any other suitable type of network and/or protocol.

In some embodiments, system memory 520 may be one embodiment of a computer-accessible medium configured to store program instructions and data as described above for FIGS. 1-4 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 500 via I/O interface 530. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 500 as system memory 520 or another type of memory. Further, a computer-accessible medium may include transmission media or signals such as electrical, electromagnetic or digital signals, conveyed via a communication medium such as a network and/or a wireless link, such as may be implemented via network interface 540. Portions or all of multiple computing devices, such as those illustrated in FIG. 5, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 5, may include other components that are not explicitly shown in FIG. 5, or may utilize an architecture completely different than that shown in FIG. 5.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A system comprising:
one or more processors; and
a memory in communication with the one or more processors, the memory having computer-readable instructions stored thereupon that, when executed by the one or more processors, cause the system to instantiate a validation engine configured to verify user goal states in a virtualized computing environment comprising a plurality of hosts executing a plurality of virtual machines or containers, the validation engine configured to perform operations comprising:
accessing a representation of a user goal state encoding an updated state of the virtualized computing environment;
determining a current state of the virtualized computing environment by sending, by the validation engine, queries to control plane components of the virtualized computing environment to obtain current states of the plurality of hosts;
sending agents to each of the plurality of hosts, the agents configured to verify local configurations of the plurality of hosts;
receiving, from the agents, verifications of the local configurations of the plurality of hosts;
comparing the current states of the plurality of hosts and local configurations of the plurality of hosts against the user goal state;
based on the comparing, verifying that the current states and local configurations are consistent with the user goal state; and
outputting an indication that the current state and local configurations are consistent with the user goal state.

Clause 2: The system of clause 1, wherein the agents are configured to verify local configurations by determining programming of the hosts.

Clause 3: The system of any of clauses 1-2, wherein the validation engine is instantiated as a remote service in a data center.

Clause 4: The system of any of clauses 1-3, wherein new scenarios that are onboarded in the virtualized computing environment are onboarded to the validation engine.

Clause 5: The system of any of clauses 1-4, wherein the validation engine includes a networking driver and an SDN device abstraction layer.

Clause 6: The system of any of clauses 1-5, wherein the SDN device abstraction layer is configured to interact with SDN devices and associated data path drivers and access what is programmed on the data path drivers.

Clause 7: The system of clauses 1-6, wherein the user goal state is persisted and compared with driver representation of the goal state.

Clause 8: A computer-readable storage medium having computer-executable instructions stored thereupon which, when executed by one or more processors of a system, cause the system to perform operations comprising:
accessing a representation of a user goal state encoding an updated state of a virtualized computing environment;
determining a current state of the virtualized computing environment by sending, by a validation engine, queries to control plane components of the virtualized computing environment to obtain current states of a plurality of hosts of the virtualized computing environment;
sending agents to each of the plurality of hosts, the agents configured to determine local configurations of the plurality of hosts;
receiving, from the agents, verifications of the local configurations of the plurality of hosts;
comparing the current states of the plurality of hosts and local configurations of the plurality of hosts against the user goal state;
based on the comparing, verifying that the current states and local configurations are consistent with the user goal state; and
sending an output indicating that the current state and local configurations are consistent with the user goal state.

Clause 9: The computer-readable storage medium of clause 8, wherein the agents are configured to verify local configurations by determining programming of the hosts.

Clause 10: The computer-readable storage medium of any of clauses 8 and 9, wherein the validation engine is instantiated as a remote service in a data center.

Clause 11: The computer-readable storage medium of any clauses 8-10, wherein new scenarios that are onboarded in the virtualized computing environment are onboarded to the validation engine.

Clause 12: The computer-readable storage medium of any clauses 8-11, wherein the validation engine includes a data driver and an SDN device abstraction layer.

Clause 13: The computer-readable storage medium of any clauses 8-12, wherein the SDN device abstraction layer is configured to interact with SDN devices and associated data path drivers and access what is programmed on the data path drivers.

Clause 14: The computer-readable storage medium of any clauses 8-13, wherein the user goal states is persisted and translated to network appliances of the SDN.

Clause 15: A method comprising:
accessing a representation of a user goal state encoding an updated state of a virtualized computing environment;
determining a current state of the virtualized computing environment by sending, by a validation engine, queries to control plane components of the virtualized computing environment to obtain current states of a plurality of hosts of the virtualized computing environment;
sending agents to each of the plurality of hosts, the agents configured to determine local configurations of the plurality of hosts;
receiving, from the agents, verifications of the local configurations of the plurality of hosts;
comparing the current states of the plurality of hosts and local configurations of the plurality of hosts against the user goal state;
based on the comparing, verifying that the current states and local configurations are consistent with the user goal state; and
generating an output a message indicating that the current state and local configurations are consistent with the user goal state.

Clause 16: The method of clause 15, wherein the agents are configured to verify local configurations by determining programming of the hosts.

Clause 17: The method of any of clauses 15 and 16, wherein the validation engine is instantiated as a remote service in a data center.

Clause 18: The method of any of clauses 15-17, wherein new scenarios that are onboarded in the virtualized computing environment are onboarded to the validation engine.

Clause 19: The method of any of clauses 15-18, wherein the validation engine includes a data driver and an SDN device abstraction layer.

Clause 20: The method of any of clauses 15-19, wherein:
the SDN device abstraction layer is configured to interact with SDN devices and associated data path drivers and access what is programmed on the data path drivers; and
the user goal state is persisted and translated to network appliances of the SDN.

1. A system comprising:
one or more processors; and
a memory in communication with the one or more processors, the memory having computer-readable instructions stored thereupon that, when executed by the one or more processors, cause the system to instantiate a validation engine configured to verify user goal states in a virtualized computing environment comprising a plurality of hosts executing a plurality of virtual machines or containers, the validation engine configured to perform operations comprising:
accessing a representation of a user goal state encoding an updated state of the virtualized computing environment;
determining a current state of the virtualized computing environment by sending, by the validation engine, queries to control plane components of the virtualized computing environment to obtain current states of the plurality of hosts;
sending agents to each of the plurality of hosts, the agents configured to verify local configurations of the plurality of hosts;
receiving, from the agents, verifications of the local configurations of the plurality of hosts;
comparing the current states of the plurality of hosts and local configurations of the plurality of hosts against the user goal state;
based on the comparing, verifying that the current states and local configurations are consistent with the user goal state; and
outputting an indication that the current state and local configurations are consistent with the user goal state.

2. The system of claim 1, wherein the agents are configured to verify local configurations by determining programming of the hosts.

3. The system of claim 1, wherein the validation engine is instantiated as a remote service in a data center.

4. The system of claim 1, wherein new scenarios that are onboarded in the virtualized computing environment are onboarded to the validation engine.

5. The system of claim 1, wherein the validation engine includes a networking driver and an SDN device abstraction layer.

6. The system of claim 5, wherein the SDN device abstraction layer is configured to interact with SDN devices and associated data path drivers and access what is programmed on the data path drivers.

7. The system of claim 5, wherein the user goal state is persisted and compared with driver representation of the goal state.

8. A computer-readable storage medium having computer-executable instructions stored thereupon which, when executed by one or more processors of a system, cause the system to perform operations comprising:
accessing a representation of a user goal state encoding an updated state of a virtualized computing environment;
determining a current state of the virtualized computing environment by sending, by a validation engine, queries to control plane components of the virtualized computing environment to obtain current states of a plurality of hosts of the virtualized computing environment;
sending agents to each of the plurality of hosts, the agents configured to determine local configurations of the plurality of hosts;
receiving, from the agents, verifications of the local configurations of the plurality of hosts;
comparing the current states of the plurality of hosts and local configurations of the plurality of hosts against the user goal state;
based on the comparing, verifying that the current states and local configurations are consistent with the user goal state; and
sending an output indicating that the current state and local configurations are consistent with the user goal state.

9. The computer-readable storage medium of claim 8, wherein the agents are configured to verify local configurations by determining programming of the hosts.

10. The computer-readable storage medium of claim 8, wherein the validation engine is instantiated as a remote service in a data center.

11. The computer-readable storage medium of claim 8, wherein new scenarios that are onboarded in the virtualized computing environment are onboarded to the validation engine.

12. The computer-readable storage medium of claim 8, wherein the validation engine includes a data driver and an SDN device abstraction layer.

13. The computer-readable storage medium of claim 12, wherein the SDN device abstraction layer is configured to interact with SDN devices and associated data path drivers and access what is programmed on the data path drivers.

14. The computer-readable storage medium of claim 12, wherein the user goal states is persisted and translated to network appliances of the SDN.

15. A method comprising:
accessing a representation of a user goal state encoding an updated state of a virtualized computing environment;
determining a current state of the virtualized computing environment by sending, by a validation engine, queries to control plane components of the virtualized computing environment to obtain current states of a plurality of hosts of the virtualized computing environment;
sending agents to each of the plurality of hosts, the agents configured to determine local configurations of the plurality of hosts;
receiving, from the agents, verifications of the local configurations of the plurality of hosts;
comparing the current states of the plurality of hosts and local configurations of the plurality of hosts against the user goal state;
based on the comparing, verifying that the current states and local configurations are consistent with the user goal state; and
generating an output a message indicating that the current state and local configurations are consistent with the user goal state.

16. The method of claim 15, wherein the agents are configured to verify local configurations by determining programming of the hosts.

17. The method of claim 15, wherein the validation engine is instantiated as a remote service in a data center.

18. The method of claim 15, wherein new scenarios that are onboarded in the virtualized computing environment are onboarded to the validation engine.

19. The method of claim 15, wherein the validation engine includes a data driver and an SDN device abstraction layer.

20. The method of claim 19, wherein:
the SDN device abstraction layer is configured to interact with SDN devices and associated data path drivers and access what is programmed on the data path drivers; and
the user goal state is persisted and translated to network appliances of the SDN.
